(19) United States
(12) Patent Application Publication
(10) Pub. No.: US 2019/0318674 A1
(43) Pub. Date: Oct. 17, 2019

(54) SYSTEM OF PRODUCING VISUAL EFFECTS

(71) Applicant: David Ralph Cicirelli, Jersey City, NJ (US)

(72) Inventor: David Ralph Cicirelli, Jersey City, NJ (US)

(21) Appl. No.: 16/363,151

(22) Filed: Mar. 25, 2019

Related U.S. Application Data
(60) Provisional application No. 62/621,647, filed on Jan. 25, 2018.

(51) Int. Cl. G09F 19/16; G09F 19/18; G09F 13/12

(52) U.S. Cl. CPC G09F 19/16; G09F 13/12; G09F 19/18

(57) ABSTRACT

A system of producing visual effects. The system includes an enclosure and a digital video display. The enclosure includes a plurality of sidewalls each having a reflective inner surface facing one other. At least one of the plurality of sidewalls is a first semi-reflective sidewall. The digital video display is positioned to direct digital video imagery through the semi-reflective sidewall and into the enclosure. Light of the digital video imagery reflects off the reflective inner surfaces of plurality of sidewalls.

### CROSS-REFERENCE TO RELATED APPLICATION

This application claims the benefit of priority of U.S. provisional application No. 62/621,647, filed Jan. 25, 2018, the contents of which are herein incorporated by reference.

### BACKGROUND OF THE INVENTION

The present invention relates to visual effects and, more particularly, to a system of producing visual effects.

Unique visual effects are desirable. Certain visual effect systems include an illuminated object (such as a neon or an LED light) inside a semi-reflective mirror structure. As a result, they are static or simply twinkle.

As can be seen, there is a need for an enhanced system of producing visual effects.

### SUMMARY OF THE INVENTION

In one aspect of the present invention, a system of producing visual effects comprises: an enclosure comprising a plurality of sidewalls each comprising a reflective inner surface facing one other, wherein at least one of the plurality of sidewalls is a first semi-reflective sidewall; and a digital video display positioned to direct digital video imagery through the semi-reflective sidewall and into the enclosure, wherein light of the digital video imagery reflects off the reflective inner surfaces of plurality of sidewalls.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a section view of the present invention, taken along line 2-2 in FIG. 1;

FIG. 3 is a section view of the present invention, taken along line 3-3 in FIG. 1;

FIG. 4 is a perspective view of an embodiment of the present invention;

FIG. 5 is a section view of the present invention, taken along line 5-5 in FIG. 4;

FIG. 6 is a perspective view of an embodiment of the present invention;

FIG. 7 is a perspective view of an embodiment of the present invention;

FIG. 8 is a perspective view of an embodiment of the present invention.

FIG. 9 is a perspective view of an embodiment of the present invention; and

FIG. 10 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a video and semi-reflective mirror configuration that creates unique visual effects. By utilizing the qualities of semi-reflective mirrors, the present invention allows video to be part of an infinity effect, endlessly reflecting and repeating on itself while creating the illusion of vast depth. The video source is placed behind the semi-reflective mirror which creates an uninterrupted infinity effect without any unwanted physical obstructions.

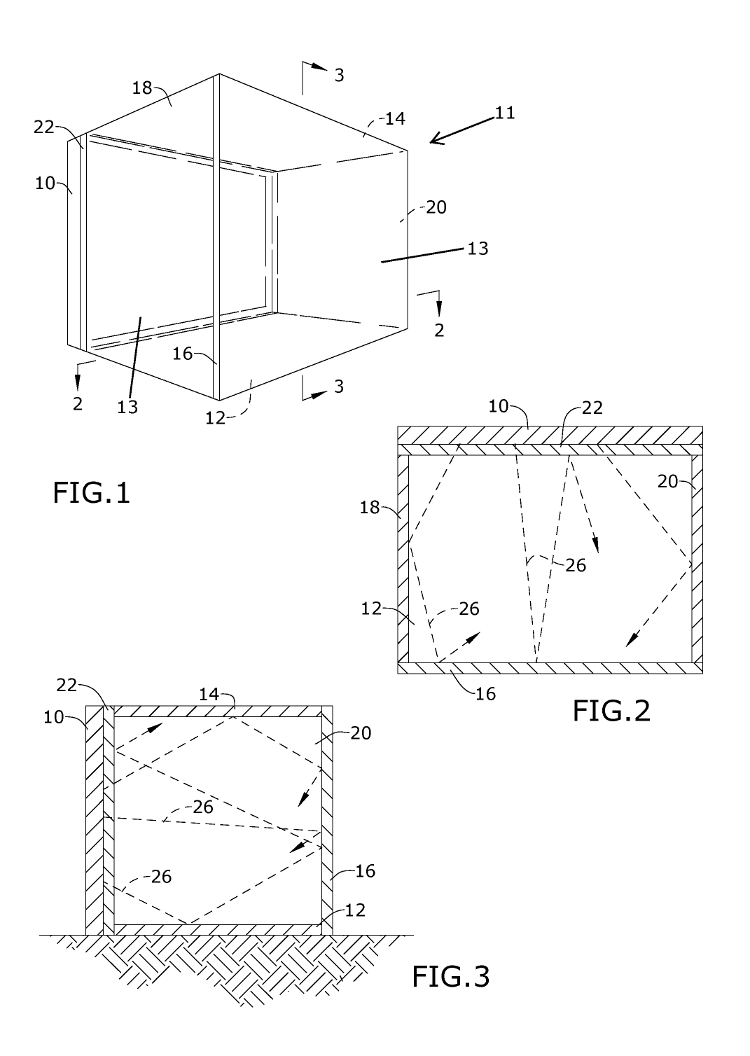

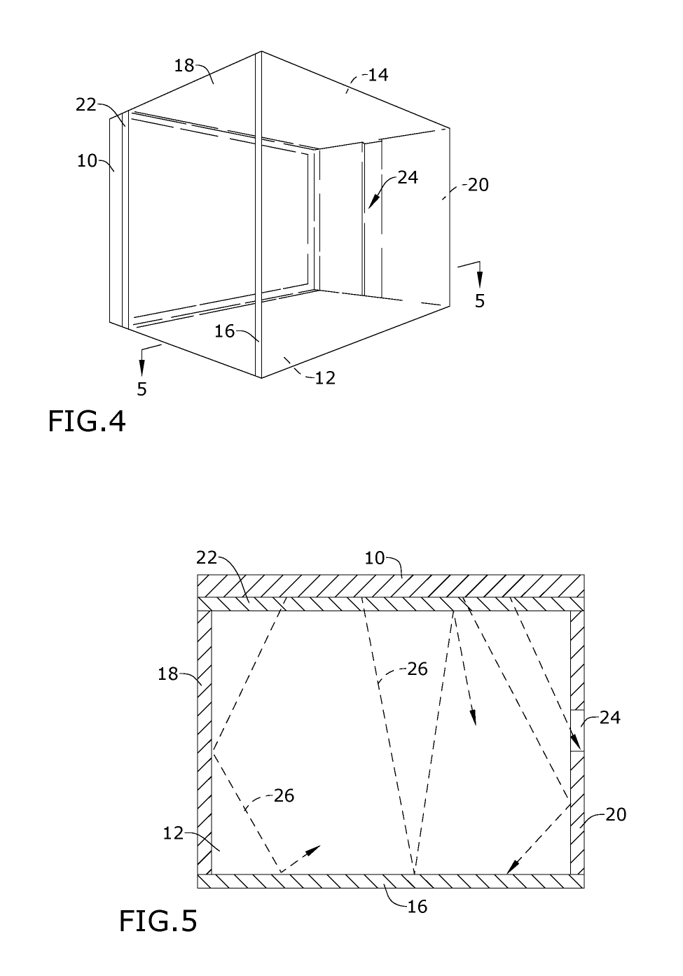

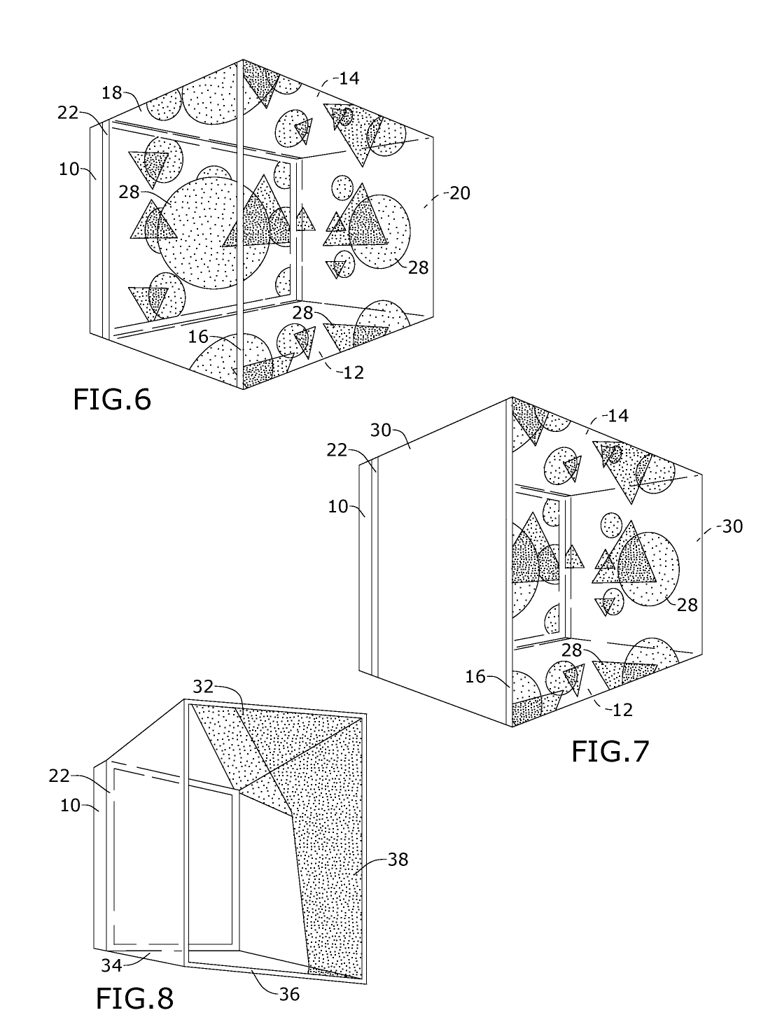

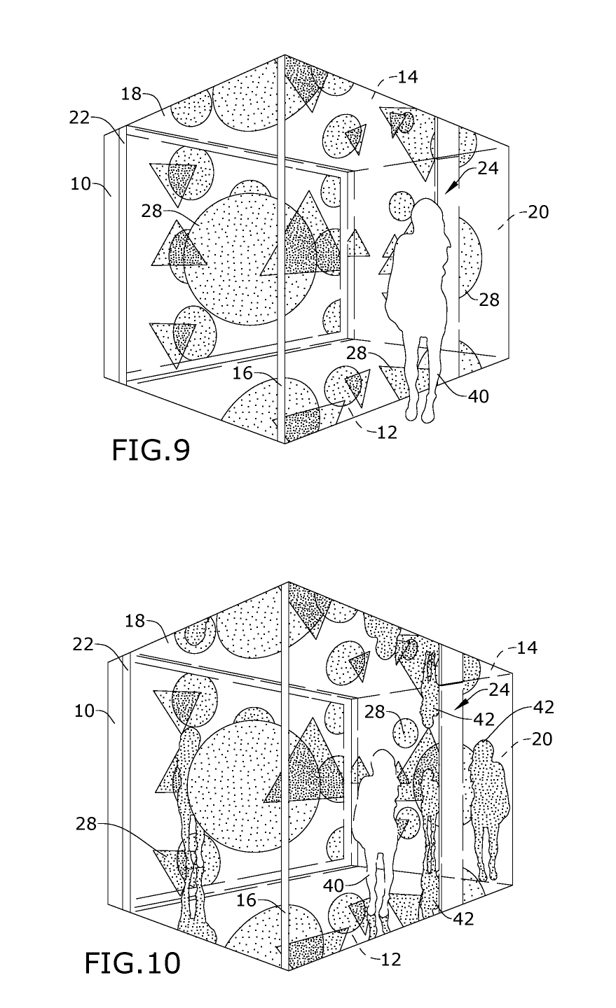

Referring now to the FIGS. 1 through 10, the present invention includes a system of producing visual effects. The system includes an enclosure 11 and a digital video display 10. The enclosure 11 includes a plurality of sidewalls 13 each having a reflective inner surface facing one other. At least one of the plurality of sidewalls 13 is a first semi-reflective sidewall 22. The digital video display 10 is positioned to direct digital video imagery through the semi-reflective sidewall 22 and into the enclosure 11. Light 26 of the digital video imagery reflects off the reflective inner surfaces of plurality of sidewalls 13.

In certain embodiments, the plurality of sidewalls 13 includes six sidewalls 13 forming a cuboid shape. The plurality of sidewalls 13 may further include a second semi-reflective sidewall 16 opposite the first semi-reflective sidewall 22. The plurality of sidewalls 13 may further includes a base 12, a top wall 14, a first side wall 18, and a second sidewall 20 each having either a semi-reflective inner surface or a fully reflective inner surface and a non-reflective outer surface 30

As mentioned above, the digital video display 10 is positioned to direct digital video imagery through the first semi-reflective sidewall 22. For example, the digital video display 10 may be directly coupled to the outer surface of the semi-reflective sidewall 22. Alternatively, the digital video display 10 may be separate from the enclosure and facing towards the first semi-reflective sidewall 22. The digital video display 10 may include, but is not limited to Light Emitting Diode displays, projectors, Plasma displays, or other types of video imaging devices.

The enclosure 11 of the present invention may include multiple configurations. For example, the enclosure 11 may include an entrance 24, such as an opening in one of the plurality of walls 13, for a user 40 to walk in and view the reflective imagery 28 as well as reflections of themselves 42. As illustrated in FIG. 8, the enclosure 11 may further include an angled ceiling 32, a first angled side wall 34, an angled base 36, and a second angled side wall 38 and therefore may not be a cuboid shape.

When projecting digital video imagery into the enclosure 11, a hall of mirror effect occurs with reflections layering onto other reflections to create the illusion of repeating content through depth. Additionally, with the digital video display 10 on the exterior of the enclosure 11, the digital video display 10 does not interrupt the effect. User's 40 then can view the effect either by being inside it (in large formats) or through the second semi-reflective sidewall 16 which acts as a window to the hall of mirrors while still contributing to the reflections itself.

A method of making the present invention may include the following. Create an enclosed or semi-enclosed shape with mirror surfaces facing inward. This shape can be fabricated any number of ways, using glass or plexiglass. At least one surface is semi-reflective. Any standard video technology may work. The video screen is placed near the exterior surface of a semi-reflective side of the mirrored enclosure 11.

The geometry of the enclosure 11 creates different effects. By displaying video content using this technique, the present invention creates a visual effect that is compelling to look at. The present invention may be utilized for: Promotional Reasons; Home decor; Artistic Expression; In-Camera Video Effects; and the like. The present invention may be used to create pop-up marketing installations, artistic use, store displays, photo booths, windows, trippy home decoration, and more.

It should be understood, of course, that the foregoing relates to exemplary embodiments of the invention and that modifications may be made without departing from the spirit and scope of the invention as set forth in the following claims.

What is claimed is:

1. A system of producing visual effects comprising:
an enclosure comprising a plurality of sidewalls each comprising a reflective inner surface facing one other, wherein at least one of the plurality of sidewalls is a first semi-reflective sidewall; and
a digital video display positioned to direct digital video imagery through the semi-reflective sidewall and into the enclosure, wherein light of the digital video imagery reflects off the reflective inner surfaces of plurality of sidewalls.

2. The system of claim 1, wherein the plurality of sidewalls comprises six sidewalls forming a cuboid shape.

3. The system of claim 1, wherein the plurality of sidewalls further comprises a second semi-reflective sidewall opposite the first semi-reflective sidewall.

4. The system of claim 3, wherein the inner surfaces of the plurality of sidewalls other than the first semi-reflective sidewall and the second semi-reflective sidewall is one of fully reflective and semi-reflective.

5. The system of claim 1, wherein the digital video display is coupled to the outer surface of the first semi-reflective sidewall.

6. The system of claim 1, wherein the enclosure further comprises an entrance.
